(19) United States
(12) Patent Application Publication
(10) Pub. No.: US 2013/0342563 A1
(43) Pub. Date: Dec. 26, 2013

(54) ELECTRONIC DEVICE WITH MIRROR FUNCTION COMMAND AND MIRROR FUNCTION

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: LING LI, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/781,681

(22) Filed: Feb. 28, 2013

(30) Foreign Application Priority Data
Jun. 26, 2012 (CN) 201210212866X

(51) Int. Cl. G09G 5/30

(52) U.S. Cl. CPC G09G 5/30
USPC 345/594; 345/593

(57) ABSTRACT

An electronic device includes a display screen, a protection layer located on the display screen, a detection unit, and a processing unit. The detection unit detects an operation of commanding a mirror function generated by a user, and produces a trigger signal when detecting the operation of commanding the mirror function. The processing unit controls the display screen to display a single high-reflection color when the trigger signal is received.

### BACKGROUND

1. Technical Field

The present disclosure relates to electronic devices, and particularly to an electronic device with mirror function.

2. Description of Related Art

Electronic devices, such as mobile phones and tablet computers have a display screen. The display screen of the electronic device can be coated or covered with a mirror film to be used as a mirror when the display screen has powered off. However, if the mirror film does not adhere to the electronic device or if the mirror film has been damaged, the electronic device will not function as a mirror.

An electronic device with a mirror function to overcome the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a cross-sectional view of one embodiment of an electronic device with mirror function.

FIG. 2 is a block diagram of one embodiment of the electronic device with mirror function of FIG. 1.

### DETAILED DESCRIPTION

Embodiments of the present disclosure will be described with reference to the accompanying drawings.

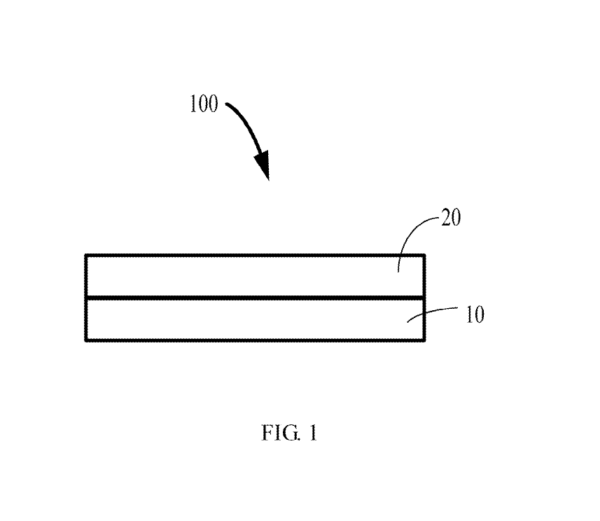

FIG. 1 illustrates a cross-sectional view of an electronic device 100 with mirror function. The electronic device 100 includes a display screen 10 and a protection layer 20. The protection layer 20 is located on the display screen 10 and protects the display screen 10. In the embodiment, the protection layer 20 is transparent and is made of transparent material, such as glass. In the embodiment, the display screen 10 is a touch screen, and the electronic device 100 can be a mobile phone, a tablet computer, or the like.

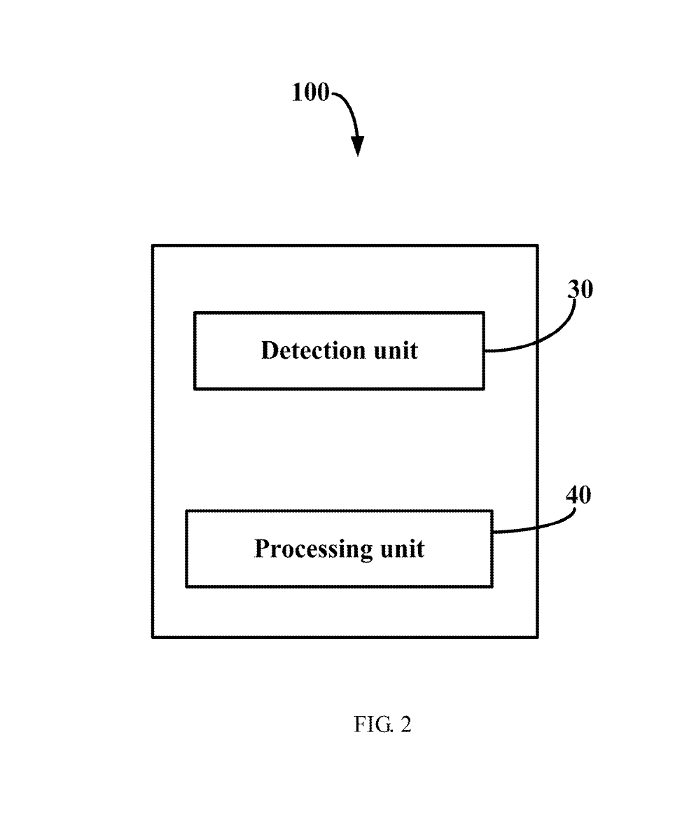

Referring to FIG. 2, the electronic device 100 also includes a detection unit 30 and a processing unit 40. The detection unit 30 detects an operation of commanding a mirror function generated by a user, and produces a trigger signal when detecting the operation of commanding the mirror function. The processing unit 40 then controls the display screen 10 to display a single color, such as gray or silver. The displayed single color is a reflective coating of the protection layer 20, the protection layer 20 combines with the single color displayed by the display screen 10 to form a mirror. In the embodiment, the operation of commanding the mirror function can be generated by pressing a predetermined button or by selecting a predetermined menu item.

In the embodiment, the protection layer 20 is made of a glass coated with a water-absorbing coating and prevents the forming or accumulation of water in the form of small droplets on a surface of the protection layer 20 which would cause fogging. In the embodiment, the water absorbing coating may be made of a material(s) which includes antimony tin oxide and silicon oxides. In another embodiment, the protection layer 20 is an electrically-heated anti-fogging glass, and when the protection layer 20 is powered on, the protection layer 20 is heated and causes any fog on the surface of the protection layer 20 to evaporate. In another embodiment, the protection layer 20 is made of a glass coated with a nanometer-scale anti-fogging film.

It is understood that the present embodiments and their advantages will be understood from the foregoing description, and various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a display screen;
a protection layer, located on the display screen;
a detection unit configured to detect an operation of commanding a mirror function generated by a user and produce a trigger signal when detecting the operation of commanding the mirror function; and
a processing unit connected to the detection unit and configured to control the display screen, to display a single color when receiving the trigger signal.

2. The electronic device according to claim 1, wherein the color is gray or silver.

3. The electronic device according to claim 1, wherein the operation of commanding the mirror function is generated by pressing a predetermined button or by selecting a predetermined menu item.

4. The electronic device according to claim 1, wherein the protection layer is made of a glass coated with a water-absorbing coating.

5. The electronic device according to claim 4, wherein the water-absorbing coating comprises antimony tin oxide and silicon oxide.

6. The electronic device according to claim 1, wherein the protection layer is an electrically-heated anti-fogging glass, and when the protection layer is powered on, the protection layer is heated and causes any fog on the surface of the protection layer to evaporate.

7. The electronic device according to claim 1, wherein the protection layer is made of a glass coated with a nanometer-scale anti-fogging film.
